(19) United States
(12) Patent Application Publication
(10) Pub. No.: US 2022/0182511 A1
(43) Pub. Date: Jun. 9, 2022

(54) REMOVE VERTICAL STREAK IN SCANNED IMAGES BASED ON SERVER

(71) Applicant: Hewlett-Packard Development Company, L.P., Spring, TX (US)

(72) Inventors: Suhan SONG, Seongnam-si (KR); Hyungsoo OHK, Seongnam-si (KR); Jungtag GONG, Seongnam-si (KR)

(21) Appl. No.: 17/604,953

(22) PCT Filed: May 20, 2020
(86) PCT No.: PCT/US2020/033716

§ 371 Date: Oct. 19, 2021

(30) Foreign Application Priority Data
Oct. 2, 2019 (KR) 10-2019-0122667

(51) Int. Cl. H04N 1/409; H04N 1/00

(52) U.S. Cl. CPC H04N 1/4097; H04N 1/00029; H04N 1/00018

(57) ABSTRACT

An example operating method of a server includes obtaining vertical streak information or scanning environment information about a vertical streak detected in a scanned image, diagnosing a severity of the vertical streak or predicting formation of the vertical streak based on the vertical streak information or the scanning environment information, and transmitting, to the image forming device or a management device managing the image forming device, action information for reducing a vertical streak occurrence, based on a result of diagnosing the severity of the vertical streak or predicting formation of the vertical streak.

### BACKGROUND

The quality of a scanned image may correspond to a state of a scanning glass in a scanning device of an image forming device or a cover in the scanning device. When foreign matter or dust occurs on the scanning glass or the cover, a vertical streak may be included in the scanned image generated by a scan job. A vertical streak occurrence may occur in a low-temperature or a dry environment.

### BRIEF DESCRIPTION OF DRAWINGS

Various examples will be described below by referring to the following figures, in which:

FIG. 1 is a conceptual diagram for describing an operation of an image forming device and a server to remove a vertical streak, according to an example;

FIG. 2 is a flowchart illustrating an operating method of a server, according to an example;

FIG. 3 is a view for describing a method of obtaining vertical streak information in an image forming device, according to an example;

FIG. 4 is a view of an artificial neural network used for diagnosing a severity of a vertical streak or predicting formation of a vertical streak, according to an example;

FIG. 5 is a view for describing an operation in which a server diagnoses a severity of a vertical streak based on a trained model for diagnosing the severity of a vertical streak, according to an example;

FIG. 6 is a view for describing an operation in which a server determines an intensity level of adjusting a sensitivity of removing a vertical streak according to a severity of the vertical streak, according to an example;

FIG. 7 is a view for describing an operation in which an image forming device displays guide information for removing a vertical streak, based on a result of diagnosing a severity of the vertical streak, according to an example;

FIG. 8 is a view for describing an operation in which a server predicts formation of a vertical streak based on a trained model for predicting formation of the vertical streak, according to an example;

FIG. 9 is a view for describing an operation in which an image forming device displays guide information for preventing formation of a vertical streak, based on a result of predicting formation of a vertical streak, according to an example;

FIGS. 10A to 10C are views for describing a method of detecting a vertical streak candidate pixel, according to an example;

FIG. 11 is a view for describing a method of detecting a vertical streak based on information of a vertical streak candidate pixel, according to an example;

FIG. 12 is a view for describing an operation between an image forming device, a server, and a management device for removing a vertical streak occurring in a scan job, according to an example;

FIG. 13 is a view for describing operations of an image forming device and a server for preventing formation of a vertical streak in a scan job, according to an example;

FIG. 14 is a block diagram of a configuration of a server according to an example; and

FIG. 15 is a block diagram of a configuration of an image forming device according to an example.

### DETAILED DESCRIPTION OF EXAMPLES

An “image forming device” may refer to any device capable of performing an image forming job, such as a printer, a copier, a scanner, a fax machine, a multi-function printer (MFP), or a display device. Also, “print data” may refer to data converted into a printable format in a printer. A “scan file” may refer to a file generated by scanning an image with a scanner.

Below, a description of examples is provided with reference to the attached drawings. In this regard, the examples may have different forms and should not be construed as being limited to the descriptions set forth herein.

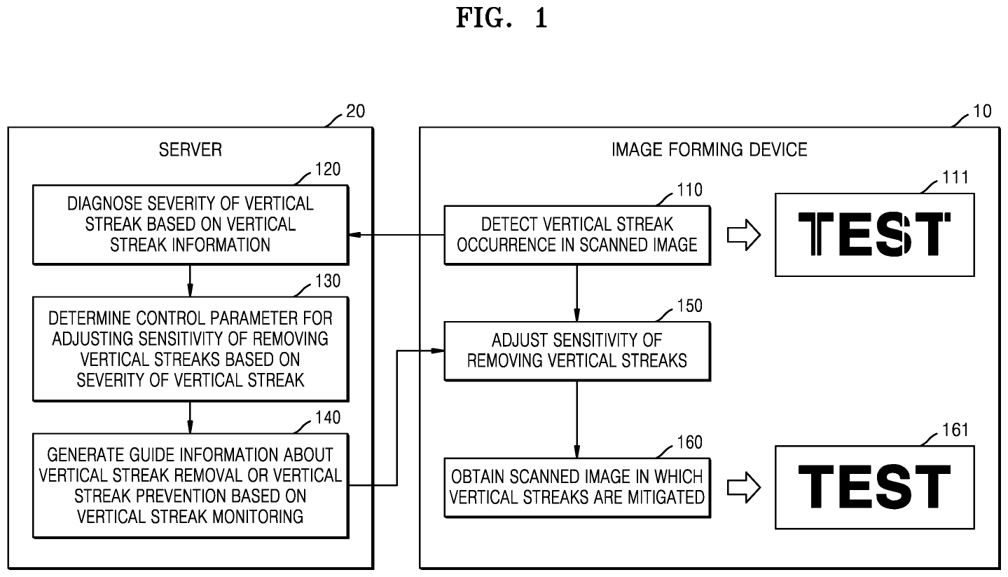

FIG. 1 is a conceptual diagram for describing an operation of an image forming device and a server to remove a vertical streak, according to an example.

Referring to FIG. 1, an image forming device 10 may detect a vertical streak occurrence from a scanned image 111 generated according to a scan job in operation 110. The vertical streak occurrence may include a black or a white vertical streak in the scanned image 111 as shown in the scanned image 111 of FIG. 1. In an example, the streak may be generated due to dust in a scanning environment of the image forming device 10. The image forming device 10 may obtain vertical streak information about the vertical streak detected in the scanned image 111, and may transmit the vertical streak information to a server 20.

In operation 120, the server 20 may diagnose a severity of the vertical streak based on the vertical streak information. The severity of the vertical streak may be the basis for determining an intensity level that adjusts a sensitivity of removing vertical streaks.

In operation 130, the server 20 may determine a control parameter for adjusting the sensitivity of removing vertical streaks based on the severity of the vertical streak. For example, when the severity of the vertical streak is higher than a reference severity, the server 20 may adjust the value of the control parameter upward. In operation 140, the server 20 may generate guide information about vertical streak removal or vertical streak prevention based on vertical streak monitoring of the image forming device 10. The server 20 may transmit the guide information to the image forming device 10.

In operation 150, the image forming device 10 may adjust the sensitivity of removing vertical streaks based on the guide information received from the server 20. In operation 160, the image forming device 10 may perform a scan job according to the adjusted sensitivity of removing vertical streaks. As illustrated in an image 161, the image forming device 10 may obtain a scanned image in which a vertical streak is mitigated.

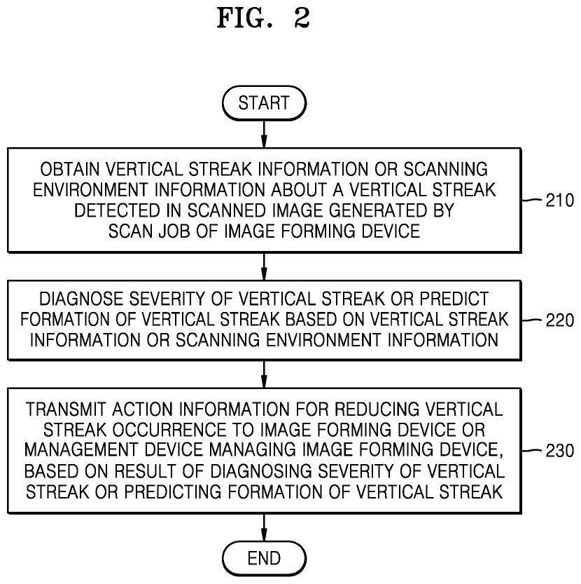

FIG. 2 is a flowchart illustrating an operating method of a server, according to an example.

Referring to FIG. 2, the server 20 may obtain vertical streak information or scanning environment information about a vertical streak detected in a scanned image generated by a scan job of the image forming device 10 in operation 210.

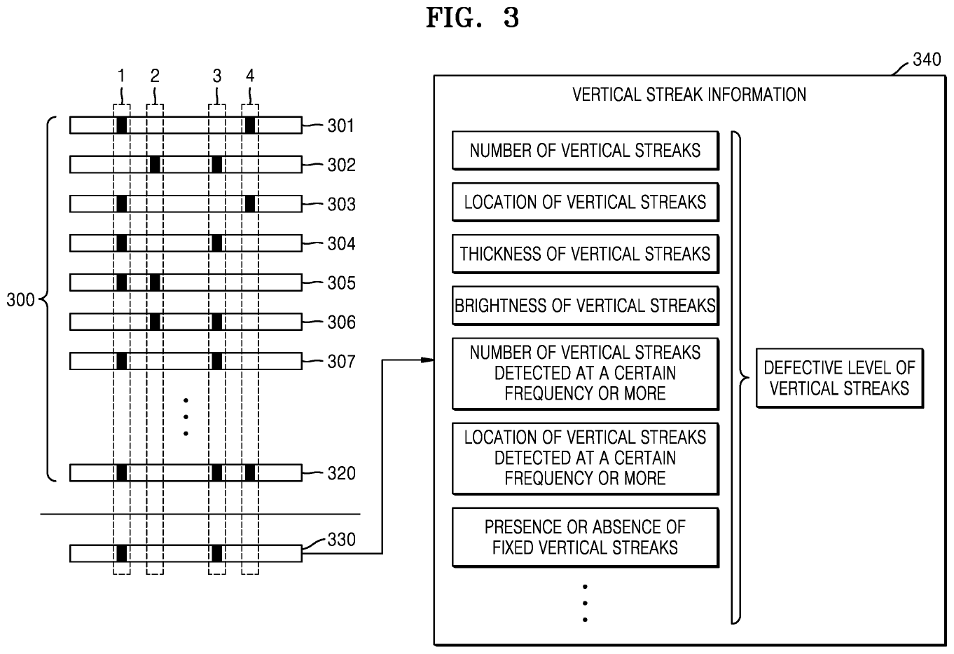

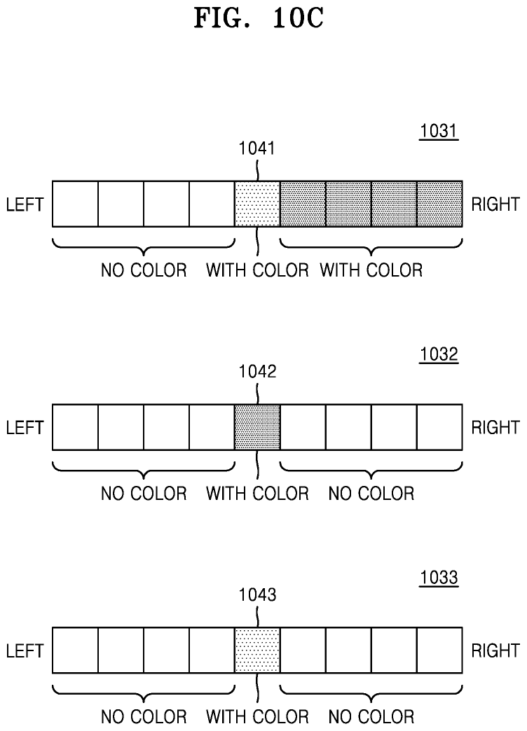

In an example, the vertical streak information may be obtained based on a location, a thickness, a brightness, or a number of a vertical streak detected in each scanned image generated by the scan job. For example, a vertical streak may be detected based on information in which vertical streak candidate information about vertical streak candidate pixels detected in a plurality of scanned images is accumulated. An example method of detecting a vertical streak will be described with reference to FIGS. 3 and 11. The vertical streak information may be obtained as vertical streak sub information, and the vertical streak information may be obtained based on a result of accumulating pieces of vertical streak sub information. For example, vertical streak sub information about vertical streaks detected in scanned images of 20 pages may be obtained, and ten pieces of vertical streak sub information may be accumulated from each page to obtain the vertical streak information. That is, certain vertical streak information may be detected in scanned images corresponding to 200 pages.

The vertical streak information may include a number, a location, a thickness, or a brightness of a vertical streak included in an accumulated certain scan job load, a number or a location of a vertical streak detected at a certain frequency or more, a presence or absence of a fixed vertical streak, or a defective level of vertical streaks. In an example, the defective level of vertical streaks may be determined based on the number, the location, the thickness, or the brightness of vertical streaks, the number or the location of vertical streaks detected at the certain frequency or more, or the presence or absence of fixed vertical streaks.

In an example, the scanning environment information may include a temperature or a humidity of a location where the image forming device 10 is installed, a scan format of a certain scan job, a number of scans, etc.

In an example, when the vertical streak information is obtained in the image forming device 10, the server 20 may periodically request the vertical streak information from the image forming device 10. The server 20 may receive the vertical streak information from the image forming device 10.

When the image forming device 10 transmits the vertical streak candidate information about the vertical streak candidate pixels detected in the plurality of scanned images to the server 20, the server 20 may detect the vertical streak based on the vertical streak candidate information, and may obtain vertical streak information about the detected vertical streak.

In operation 220, the server 20 may diagnose a severity of the vertical streak or predict formation of the vertical streak based on the vertical streak information or the scanning environment information.

For example, the server 20 may diagnose the severity of the vertical streak based on the vertical streak information. In addition, the server 20 may diagnose the severity of the vertical streak based on the vertical streak information and the scanning environment information.

For example, the severity of the vertical streak may indicate the extent to which the vertical streak on the scanned image has damaged content of the scanned image or a quality of the scanned image. Here, the severity of the vertical streak may be a reference for determining an intensity level that adjusts the sensitivity of removing vertical streaks that may occur by a scan job of the image forming device 10. For example, the severity of the vertical streak may be expressed numerically.

For example, the server 20 may diagnose the severity of the vertical streak based on a frequency at which the defective level of vertical streaks exceeds a threshold level. Here, the defective level of vertical streaks may be determined based on the number, the location, the thickness, or the brightness of vertical streaks included in a certain scan job load, the number or the location of vertical streaks detected at the certain frequency or more, or the presence or absence of fixed vertical streaks. The threshold level may indicate a level at which adjustment of an intensity level that adjusts the sensitivity of removing vertical streaks is necessary.

As an example, when the number of times the defective level exceeds the threshold level is less than three times in a certain scan job load, the severity of the vertical streak may be considered normal. In an example, when the number of times the defective level exceeds the threshold level is three or more times and less than seven times, the severity of the vertical streak may be considered high. In an example, when the number of times the defective level exceeds the threshold level is seven or more times, the severity of the vertical streak may be considered very high. When the number of times the defective level for vertical streaks exceeds the threshold level in a certain scan job load is five or more times, the server 20 may determine that the severity of vertical streaks is high.

The server 20 may diagnose the severity of a first vertical streak by applying first vertical streak information about a first scan job or first scanning environment information at a time of the first scan job to a trained model for diagnosing a severity of a vertical streak for a certain scanned image generated by a certain scan job of the image forming device 10.

In an example, the trained model for diagnosing the severity of the vertical streak may be the trained model for diagnosing the severity of the vertical streak for the certain scanned image, based on a correlation between pieces of vertical streak information and user's feedback information about the pieces of vertical streak information, or a correlation between the pieces of vertical streak information and pieces of scanning environment information about the pieces of vertical streak information. For example, the user's feedback information about the pieces of vertical streak information may include history information with the sensitivity adjusted to remove vertical streaks in the image forming device 10 or history information for applying for a diagnosis or repair service due to a vertical streak occurrence. That is, the server 20 diagnoses the severity of the vertical streak by reflecting a correlation between vertical streak information and user's feedback information or a correlation between characteristics of vertical streaks and characteristics of a scanning environment in which the vertical streaks are detected, thereby accurately diagnosing the severity according to the state of vertical streaks included in a scanned image.

For example, the server 20 may predict formation of the vertical streak based on the vertical streak information or the scanning environment information. The vertical streak information may include vertical streak candidate information. The vertical streak candidate information may be obtained based on a location, a brightness, or a number of vertical streak candidate pixels detected in a scanned image.

For example, the server 20 may obtain the scanning environment information during the first scan job of the image forming device 10 and the vertical streak candidate information in a scanned image generated before the first scan job. The server 20 may receive the scanning environment information and the vertical streak candidate information from the image forming device 10.

For example, the scanning environment information may include the temperature or the humidity of the location where the image forming device 10 is installed, the scan format, or the number of scans. The vertical streak candidate information may be obtained based on the location, the brightness, or the number of vertical streak candidate pixels detected in the scanned image. The server 20 may predict formation of a vertical streak due to a certain scan job by applying the scanning environment information or the vertical streak candidate information to a trained model for predicting formation of a vertical streak for a certain scanned image to be generated by a certain scan job of the image forming device 10.

Here, the trained model for predicting formation of the vertical streak may be a trained model that predicts formation of a vertical streak for a certain scanned image, based on a correlation between pieces of vertical streak information and pieces of scanning environment information about the pieces of vertical streak information, or a correlation between the pieces of vertical streak information and pieces of vertical streak candidate information corresponding to the pieces of vertical streak information.

That is, the trained model for predicting formation of the vertical streak may generate a trained model that predicts in which scanning environment the vertical streak may occur during scanning and in which vertical streak candidate the vertical streak may occur during scanning, by learning a correlation between the scanning environment of the image forming device 10 and whether a vertical streak forms in the scanning environment or a correlation between vertical streak information and vertical streak candidate information corresponding to the vertical streak information.

In operation 230, the server 20 may transmit action information for reducing a vertical streak occurrence to the image forming device 10 or a management device 30 managing the image forming device 10, based on a result of diagnosing the severity of the vertical streak or predicting formation of the vertical streak.

For example, the action information for reducing the vertical streak occurrence may include information of a certain intensity level for adjusting the sensitivity of removing vertical streaks to be occurred by at least one scan job of the image forming device 10, guide information for guiding the operation of the image forming device 10 such that at least one scan job is performed while a certain intensity level is applied, information about diagnosis of the severity of the vertical streak, information about prediction of formation of the vertical streak, or notification information informing of a visiting service to the image forming device 100.

For example, regarding the determination of an intensity level, the server 20 may determine a first intensity level based on a result of diagnosing the severity of the vertical streak or predicting formation of the vertical streak.

For example, if the severity of the vertical streak is determined to be higher than a preset reference severity or if a certain vertical streak is expected to occur, the server 20 may determine the intensity level as a first intensity level adjusted upward from a reference intensity level.

For example, if the severity of vertical streaks is determined to be lower than the preset reference severity, the server 20 may maintain the intensity level at the reference intensity level. Here, if there is a history in which the intensity level is adjusted upward from the reference intensity level, the server 20 may determine the first intensity level by adjusting the intensity level downward.

The server 20 may transmit action information including information of the first intensity level to the image forming device 10 or the management device 30 managing the image forming device 10.

For example, the server 20 may transmit, to the image forming device 10, guide information for guiding the operation of the image forming device 10 to perform at least one scan job in a state where the first intensity level is applied to the intensity level.

For example, the server 20 may transmit, to the image forming device 10, information about diagnosis of the severity of the vertical streak, information about prediction of formation of the vertical streak, or notification information regarding a service visit to the image forming device 10.

For example, when formation of the first vertical streak due to a certain scan job is predicted from the scanning environment information, the server 20 may obtain first guide information for guiding prevention of formation of the first vertical streak. The server 20 may transmit the first guide information to the image forming device 10.

FIG. 3 is a view for describing a method of obtaining vertical streak information in an image forming device, according to an example.

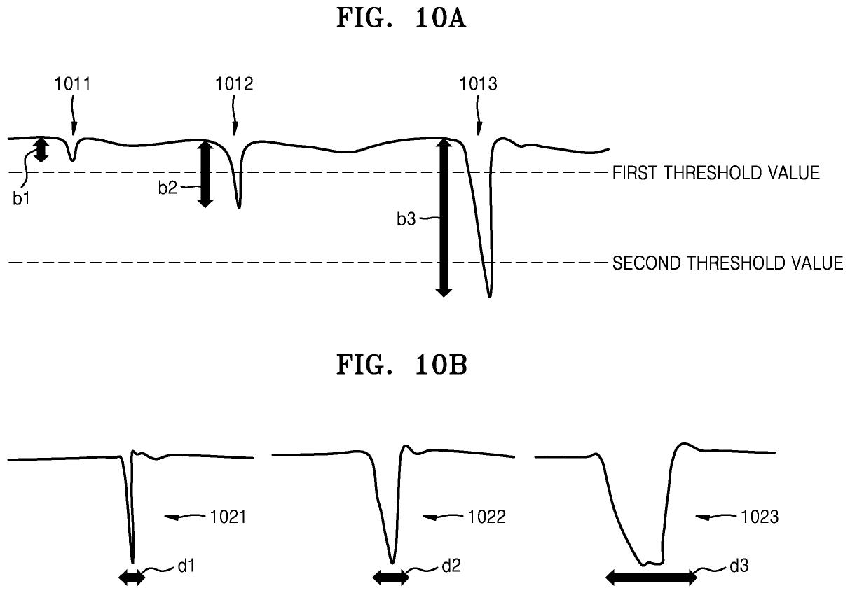

Referring to FIG. 3, the image forming device 10 may obtain vertical streak candidate information 301, 302, 303, 304, 305, 306, 307, and 320 for each scan page and store the vertical streak candidate information 301, 302, 303, 304, 305, 306, 307, and 320 during a scan job. For example, the vertical streak candidate information 301, 302, 303, 304, 305, 306, 307, and 320 may include location information 1, 2, 3, and 4 of vertical streak candidate pixels. An example method of detecting the vertical streak candidate pixels is described with reference to FIGS. 10A to 10C.

The image forming device 10 may detect a vertical streak based on a result of accumulating pieces of vertical streak candidate information 300. For example, the image forming device 10 may detect a pixel having continuity in a sub-scanning direction among the vertical streak candidate pixels based on the result of accumulating the pieces of vertical streak candidate information 300. The pixel having continuity (i.e., a continuity pixel) may be a pixel in which a length of continuity of the vertical streak candidate pixel is a certain length or more in the sub-scanning direction, or a frequency of continuity of the vertical streak candidate pixel is a certain frequency or more. The image forming device 10 may detect a vertical streak based on the location information 1 and 3 of the pixel having continuity. An example method of detecting vertical streaks will be described with reference to FIG. 11.

The image forming device 10 may obtain vertical streak sub information 330 about a vertical streak. The image forming device 10 may obtain N values of vertical streak sub information, where N is a natural number, and may obtain vertical streak information 340 based on a result of accumulating the N values of vertical streak sub information. For example, the vertical streak information 340 may include a number, a location, a thickness, or a brightness of a vertical streak included in an accumulated scan job load, a number or a location of a vertical streak detected at a certain frequency or more, a presence or absence of a fixed vertical streak, or a defective level of vertical streaks. For example, the defective level of vertical streaks may be determined based on the number, the location, the thickness, or the brightness of vertical streaks, the number or the location of vertical streaks detected at the certain frequency or more, or the presence or absence of fixed vertical streaks.

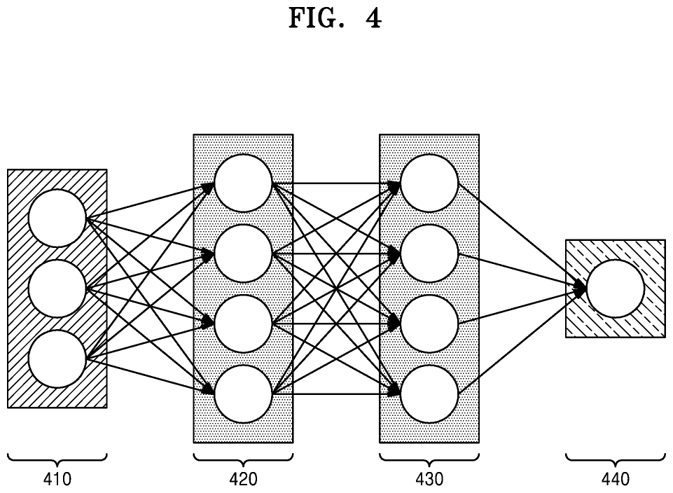

FIG. 4 is a view of an artificial neural network used for diagnosing a severity of vertical streaks or predicting formation of vertical streaks, according to an example.

Referring to FIG. 4, the server 20 may diagnose a severity of a first vertical streak by applying first vertical streak information or first scanning environment information to a trained model for diagnosing the severity of a vertical streak for a certain scanned image generated by a certain scan job of the image forming device 10. In addition, the server 20 may predict formation of a vertical streak due to a certain scan job in a first scanning environment indicated by the first scanning environment information by applying the first scanning environment information or vertical streak candidate information to a trained model for predicting formation of a vertical streak for a certain scanned image to be generated by a certain scan job of the image forming device 10. That is, the server 20 may diagnose a severity of a vertical streak or predict formation of a vertical streak using a certain trained model. In addition, when a condition for learning the certain trained model in the image forming device 10 is satisfied, the image forming device 10 may diagnose a severity of a vertical streak or predict formation of a vertical streak using the certain trained model. The certain trained model may be generated based on an artificial neural network structure.

As illustrated in FIG. 4, the artificial neural network may include an input layer 410, one or more hidden layers 420 and 430, and an output layer 440. In addition, an operation through the artificial neural network may be performed by a processor in the server 20 or a processor in the image forming device 10. Alternatively, the operation through the artificial neural network may be performed through separate processors, controllers, or chips for performing operations through separate artificial neural networks.

In an example, weights between respective layers and nodes may be learned through learning and training performed in the hidden layers 420 and 430. For example, a processor in the server 20 or a processor in the image forming device 10 may obtain, through repetitive learning, a value of a weight indicating a correlation between pieces of vertical streak information and user's feedback information about the pieces of vertical streak information or a value of a weight indicating a correlation between pieces of vertical streak information and scanning environment information about the pieces of vertical streak information. A processor in the server 20 or a processor in the image forming device 10 may generate, in a trained artificial neural network with the obtained value of the weight applied, a trained model for diagnosing a severity of a vertical streak for a certain scanned image generated by a certain scan job.

For another example, a processor in the server 20 or a processor in the image forming device 10 may obtain, through repetitive learning, a value of a weight indicating a correlation between pieces of vertical streak information and pieces of scanning environment information about the pieces of vertical streak information. Also, a processor in the server 20 or a processor in the image forming device 10 may obtain, through repetitive learning, a value of a weight indicating a correlation between pieces of vertical streak information and pieces of scanning environment information about the pieces of vertical streak information. A processor in the server 20 or a processor in the image forming device 10 may generate, in the trained artificial neural network with the obtained value of the weight applied, a trained model for predicting formation of a vertical streak for a certain scanned image to be generated by a certain scan job.

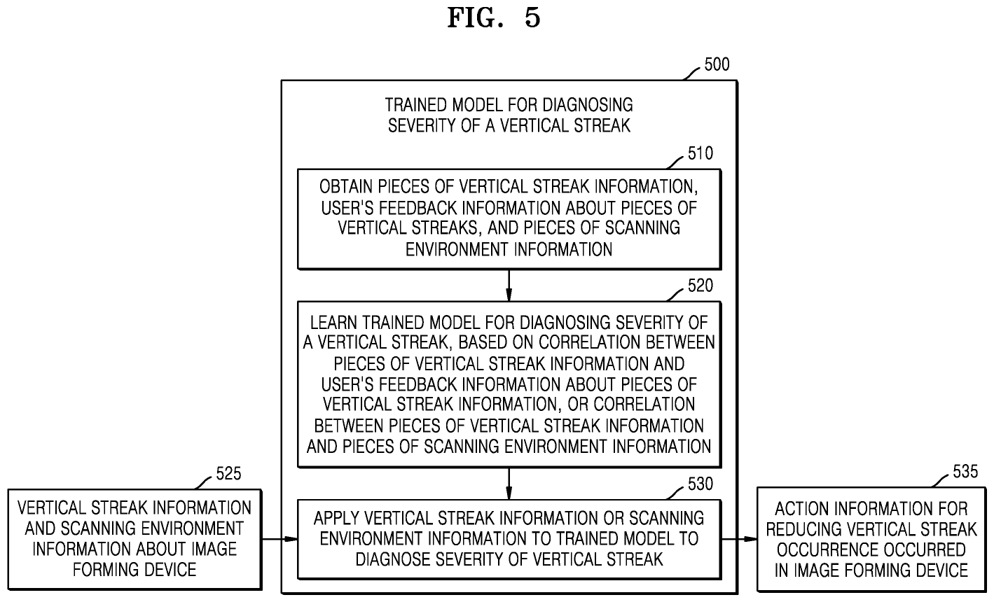

FIG. 5 is a view for describing an operation in which a server diagnoses a severity of a vertical streak based on a trained model for diagnosing the severity of a vertical streak, according to an example.

Referring to FIG. 5, the server 20 may diagnose the severity of a vertical streak occurred by a scan job of the image forming device 10 by using a trained model 500 for diagnosing the severity of a vertical streak.

In operation 510, the server 20 may obtain pieces of vertical streak information, user's feedback information about the pieces vertical streak information, and pieces of scanning environment information. For example, the vertical streak information may include a number, a location, a thickness, or a brightness of a vertical streak included in an accumulated certain scan job load, a number or a location of a vertical streak detected at a certain frequency or more, a presence or absence of a fixed vertical streak, or a defective level of vertical streaks. The pieces of vertical streak information refer to pieces of vertical streak information that are collected. In addition, the user's feedback information may include history information with the sensitivity adjusted to remove a vertical streak in the image forming device 10 or history information for applying for a diagnosis or repair service due to a vertical streak occurrence. Furthermore, the scanning environment information may include a temperature or a humidity of a location where the image forming device 10 is installed, a scan format for a certain scan job, or a number of scans.

In operation 520, the server 20 may learn the trained model 500 for diagnosing the severity of a vertical streak, based on a correlation between the pieces of vertical streak information and the user's feedback information about the pieces of vertical streak information, or a correlation between the pieces of vertical streak information and the pieces of scanning environment information about the pieces of vertical streak information.

For example, the server 20 may determine, by learning the correlation between the vertical streak information and the user's feedback information, the number, the location, the thickness, or the brightness of a vertical streak included in a certain scan job load, the number or the location of a vertical streak detected at the certain frequency or more, the presence or absence of a fixed vertical streak, and whether the certain severity of the vertical streak is high or low when a value such as a defective level of vertical streaks has a certain value.

For example, the server 20 may determine, by learning the correlation between the vertical streak information and the user's feedback information, the number, the location, the thickness, or the brightness of a vertical streak included in a certain scan job load, the number or the location of a vertical streak detected at a certain frequency or more, the presence or absence of a fixed vertical streak, or whether to increase the certain severity of vertical streaks by increasing a value such as the defective level of vertical streaks.

In operation 525, the server 20 may obtain vertical streak information and scanning environment information about the image forming device 10. In an example, the server 20 may obtain the vertical streak information and the scanning environment information about the image forming device 10 from the image forming device 10.

In operation 530, the server 20 may apply the vertical streak information or the scanning environment information to the trained model 500 to diagnose the severity of the vertical streak.

In operation 535, the server 20 may obtain action information for reducing the vertical streak occurrence based on a result of diagnosing the severity of the vertical streak occurred in the image forming device 10. For example, the server 20 may determine an intensity level that adjusts the sensitivity to remove the vertical streak. The server 20 may transmit action information including information of the intensity level to the image forming device 10 or the management device 30 managing the image forming device 10.

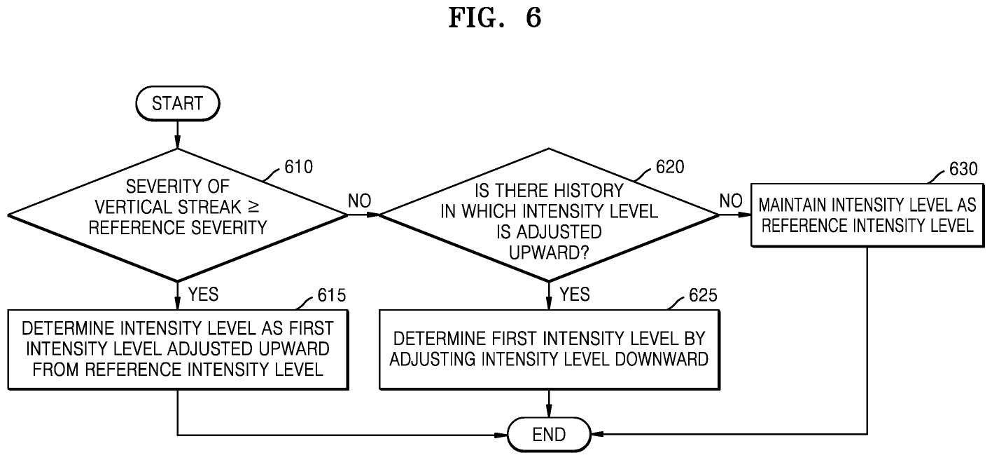

FIG. 6 is a view for describing an operation in which a server determines an intensity level of adjusting a sensitivity of removing a vertical streak according to a severity of the vertical streak, according to an example.

Referring to FIG. 6, the server 20 may determine whether a severity of a vertical streak is higher than a preset reference severity in operation 610. As a result of the determination, when the severity of the vertical streak is higher than the preset reference severity, the server 20 may perform operation 615. In addition, if it is predicted that a certain vertical streak will occur according to a certain scan job, the server 20 may perform operation 615. On the other hand, when the severity of the vertical streak is lower than the preset reference severity, the server 20 may perform operation 620.

In operation 615, the server 20 may determine the intensity level as a first intensity level adjusted upward from a reference intensity level.

In operation 620, the server 20 may determine whether there is a history in which the intensity level is adjusted upward. As a result of the determination, if there is a history in which the intensity level is adjusted upward, the server 20 may determine the first intensity level by adjusting the intensity level downward according to operation 625 of the server 20. On the other hand, if there is no history in which the intensity level is increased, the server 20 may maintain the intensity level as the reference intensity level according to operation 630 of the server 20.

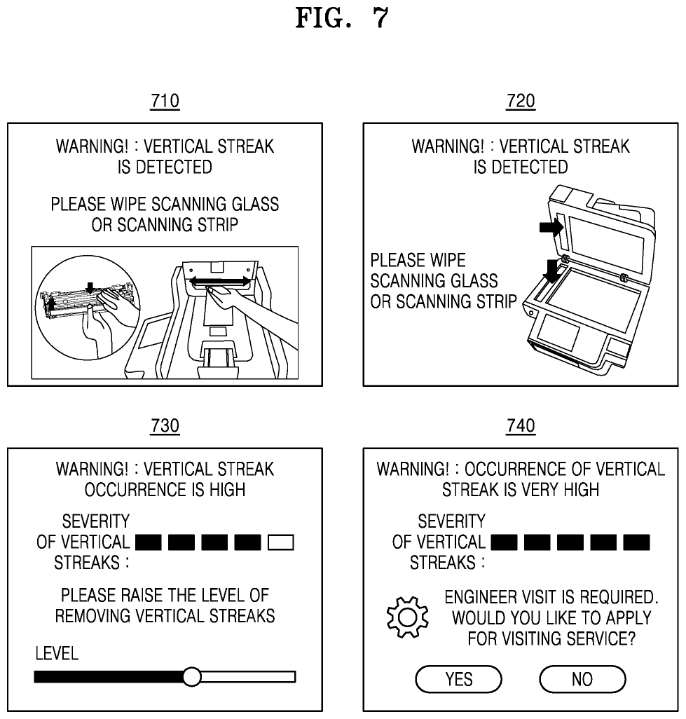

FIG. 7 is a view for describing an operation in which an image forming device displays guide information for removing a vertical streak, based on a result of diagnosing a severity of the vertical streak, according to an example.

Referring to FIG. 7, a vertical streak may be detected in the scanned image generated by a scan job of the image forming device 10. The server 20 may receive vertical streak information from the image forming device 10. The server 20 may diagnose a severity of the vertical streak based on the vertical streak information. The server 20 may determine guide information for removing the vertical streak according to the severity of the vertical streak. For example, the server 20 may classify the severity of the vertical streak into one of five grades. Grade 1 may have very low severity of vertical streak, grade 2 may have low severity of vertical streak, grade 3 may have moderate severity of vertical streak, grade 4 may have high severity of vertical streak, and grade 5 may have very high severity of vertical streak. The server 20 may generate guide information corresponding to a certain grade. The server 20 may transmit the guide information to the image forming device 10. The image forming device 10 may display the guide information received from the server 20.

Referring to an image 710 and an image 720, when the severity of the vertical streak is the grade 1 having very low severity of vertical streak or the grade 2 having low severity of vertical streak, the image forming device 10 may display guide information indicating that the vertical streak has been detected and information for guiding a scanning glass or a scanning strip to be cleaned (e.g., wiped).

Referring to an image 730, when the severity of the vertical streak is the grade 4 having high severity of vertical streak, the image forming device 10 may display guide information for guiding the level of removing vertical streaks upward.

Referring to an image 740, when the severity of the vertical streaks is the grade 5 having very high severity of vertical streak, the image forming device 10 may display guide information corresponding to an engineer visit or service visit application information.

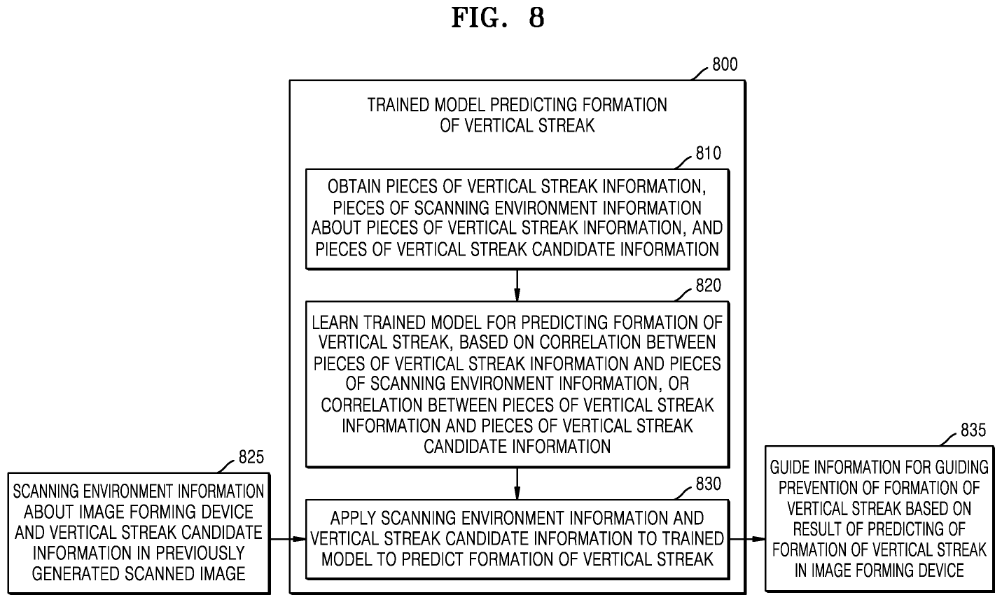

FIG. 8 is a view for describing an operation in which a server predicts formation of a vertical streak, based on a trained model predicting the formation of a vertical streak, according to an example.

Referring to FIG. 8, the server 20 may predict a possibility of formation of a vertical streak by a scan job of the image forming device 10 using a trained model 800 that predicts formation of a vertical streak. For example, the server 20 may apply vertical streak information or scanning environment information to the trained model 800 which predicts formation of a vertical streak, and may predict the possibility of formation of a vertical streak.

In operation 810, the server 20 may obtain pieces of vertical streak information, pieces of scanning environment information about the pieces of vertical streak information, and pieces of vertical streak candidate information. For example, the scanning environment information may include a temperature or a humidity of a location where the image forming device 10 is installed, a scan format, or a number of scans. The vertical streak candidate information may be obtained based on a location, a brightness, or a number of vertical streak candidate pixels detected in a scanned image.

In operation 820, the server 20 may learn the trained model 800 for predicting formation of a vertical streak, based on a correlation between the pieces of vertical streak information and the pieces of scanning environment information about the pieces of vertical streak information, or a correlation between the pieces of vertical streak information and the pieces of vertical streak candidate information.

The server 20 may predict in which scanning environment a vertical streak may form during scanning and in which vertical streak candidate a vertical streak may form during scanning, by learning a correlation between a scanning environment of the image forming device 10 and whether a vertical streak forms in the scanning environment or a correlation between vertical streak information and vertical streak candidate information corresponding to the vertical streak information.

In operation 825, the server 20 may obtain scanning environment information about the image forming device 10 and vertical streak candidate information in a previously generated scanned image. In an example, the server 20 may obtain the scanning environment information about the image forming device 10 and the vertical streak candidate information in the previously generated scanned image from the image forming device 10.

In operation 830, the server 20 may apply the scanning environment information and the vertical streak candidate information to the trained model 800 to predict formation of a vertical streak.

In operation 835, the server 20 may obtain guide information for guiding prevention of formation of a vertical streak based on a result of the predicting of formation of a vertical streak in the image forming device 10.

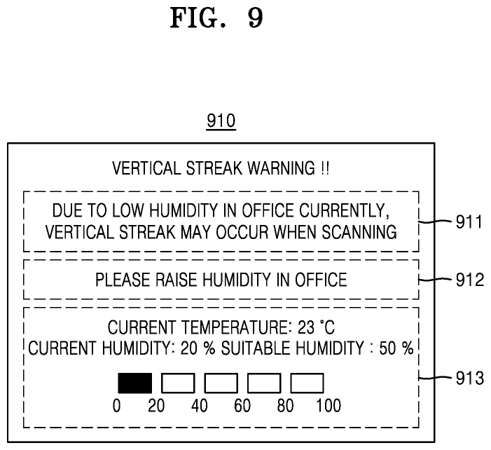

FIG. 9 is a view for describing an operation in which an image forming device displays guide information for preventing formation of a vertical streak, based on a result of predicting formation of a vertical streak, according to an example.

Referring to FIG. 9 the server 20 may receive, from the image forming device 10, scanning environment information on which a certain scan job is to be performed. The server 20 may predict whether a vertical streak may form due to a certain scan job based on the scanning environment information. When it is predicted that the probability of formation of a vertical streak at the certain scan job is high, the server 20 may generate the guide information for guiding prevention of formation of a vertical streak. The server 20 may transmit the guide information to the image forming device 10. The image forming device 10 may display the guide information received from the server 20.

Referring to an image 910, when humidity in a location (e.g., an office) where the image forming device 10 is installed is low, a vertical streak may form in a scanned image generated by the scan job when the scan job is performed in the image forming device 10.

The server 20 may predict that a vertical streak will occur during the scan job due to low humidity in the office, and may generate guide information indicating a notification to increase humidity in the office. The server 20 may transmit the guide information to the image forming device 10. The image forming device 10 may the display guide information as shown in the image 910. The guide information may include cause information 911 indicating a cause of a vertical streak occurrence, action information 912 that may prevent the vertical streak occurrence, and scanning environment information 913. The scanning environment information 913 may include information about a current value for a parameter associated with a cause of vertical streak occurrence or an appropriate value for preventing the vertical streak occurrence. For example, when the cause of the vertical streak occurrence may be related to humidity, the scanning environment information 913 may include values of current humidity and desired humidity.

FIGS. 10A to 10C are views for describing a method of detecting a vertical streak candidate pixel, according to an example.

The vertical streak candidate pixel may be determined based on characteristics of a depth, a thickness, or a color for each pole detected on a scanned image. For example, a pixel of a certain pole may be determined as the vertical streak candidate pixel based on whether the certain pole is a maximum or a minimum point, whether a difference in brightness between pixels of a certain pole and surrounding pixels is within a preset range, or based on a color presence or a color ratio between the pixels of the certain pole and the surrounding pixels.

Referring to FIG. 10A, brightness differences b1, b2, and b3 between a first pole 1011, a second pole 1012, and a third pole 1013 and respective surrounding pixels of the poles 1011, 1012, and 1013 may be calculated. It may be determined whether the calculated brightness differences b1, b2, and b3 are included in a preset brightness range. The preset brightness range may be between a first threshold value and a second threshold value. For example, the first threshold value may be a reference value that may be determined to have a low brightness difference, and the second threshold value may be a reference value that may be determined to have a high brightness difference.

Referring to FIG. 10A, a pixel of the first pole 1011 having the brightness difference b1 less than the first threshold value may be determined as a simple noise pixel because a difference in brightness from surrounding pixels is small. A pixel of the third pole 1013 having the brightness difference b3 exceeding the second threshold value may be determined as a pixel representing a content area due to a large brightness difference from surrounding pixels. A pixel of the second pole 1012 having the brightness difference b2 included between the first threshold value and the second threshold value may be determined as a vertical streak candidate pixel.

Referring to FIG. 10B, it may be determined whether thicknesses of a fourth pole 1021, a fifth pole 1022, and a sixth pole 1023 are within a preset reference thickness. For example, a pixel of the fourth pole 1021 having a thickness d1 less than the reference thickness may be determined as a vertical streak candidate pixel. The fifth pole 1022 and the sixth pole 1023 having thicknesses d2 and d3 greater than or equal to the reference thickness may be determined as pixels representing the content area.

Referring to FIG. 10C, a pixel having a certain pole may be determined as a vertical streak candidate pixel based on a color presence or a color ratio between the pixel of the certain pole and surrounding pixels.

Referring to an image 1031, when a color exists in a pixel 1041 of a certain pole, a color does not exist in surrounding pixels on the left side of the pixel 1041 of the certain pole, and a color different from the color of the pixel 1041 exists in surrounding pixels on the right side of the pixel 1041, the pixel 1041 may be determined as a vertical streak candidate pixel.

Referring to an image 1032, when a color exists in a pixel 1042 of a certain pole, a color does not exist in surrounding pixels on the left and right sides of the pixel 1042 of the certain pole, and a color ratio of the surrounding pixels to the pixel 1042 exceeds a preset reference color ratio, the pixel 1042 may be determined as a pixel representing a content area.

Referring to an image 1033, when a color exists in a pixel 1043 of a certain pole, a color does not exist in surrounding pixels on the left and right sides of the pixel 1043 of the certain pole, and a color ratio of the surrounding pixels to the pixel 1043 is less than a preset reference color ratio, the pixel 1043 may be determined as a vertical streak candidate pixel.

FIG. 11 is a view for describing a method of detecting a vertical streak based on information of a vertical streak candidate pixel, according to an example.

The image forming device 10 may obtain vertical streak candidate information about a plurality of scanned pages and store the vertical streak candidate information during a scan job. The vertical streak candidate information may include location information of the vertical streak candidate pixel. The image forming device 10 may detect a vertical streak based on a result of accumulating pieces of vertical streak candidate information (e.g., 300 of FIG. 3). The image forming device 10 may obtain vertical streak information about a vertical streak.

The image forming device 10, based on a result of accumulating the pieces of vertical streak candidate information, may determine whether vertical streak candidate pixels consecutively accumulated at a certain location are greater than or equal to a certain size or whether the frequency of formation of the vertical streak candidate pixels consecutively accumulated at a certain location is greater than or equal to a certain number. The image forming device 10 may detect, as a vertical streak, a pixel in which the vertical streak candidate pixels consecutively accumulated at a certain location are greater than or equal to a certain size, or a pixel in which the frequency of formation of the vertical streak candidate pixels consecutively accumulated at a certain location is greater than or equal to a certain number.

Referring to FIG. 11, among locations 1101, 1102, 1103, and 1104 of vertical streak candidate pixels, the image forming device 10 may detect, as a vertical streak, a vertical streak candidate pixel corresponding to the locations 1102 and 1103 where the length of continuity of the vertical streak candidate pixel is greater than or equal to a certain length or the frequency of continuity of the vertical streak candidate pixel is equal to or greater than a certain frequency.

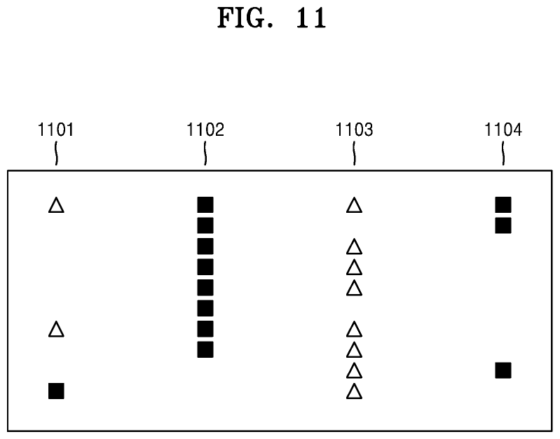

FIG. 12 is a view for describing an operation between an image forming device, a server, and a management device for removing a vertical streak occurring in a scan job, according to an example.

Referring to FIG. 12, the image forming device 10 may perform a scan job in operation 1201. In operation 1202, the image forming device 10 may detect a vertical streak in a scanned image generated by the scan job. In operation 1203, the image forming device 10 may obtain vertical streak information and scanning environment information about the vertical streak. For example, the vertical streak information may include a number, a location, a thickness, or a brightness of the vertical streak, a number or a location of the vertical streak detected at a certain frequency or more, a presence or absence of a fixed vertical streak, or a defective level of vertical streaks. For example, the scanning environment information may include a temperature or a humidity of a location where the image forming device 10 is installed, a scan format for a certain scan job, or a number of scans.

In operation 1204, the server 20 may request the vertical streak information or the scanning environment information from the image forming device 10. In operation 1205, the image forming device 10 may transmit the vertical streak information or the scanning environment information to the server 20.

In operation 1206, the server 20 may obtain the vertical streak information or the scanning environment information about the vertical streak. In operation 1207, the server 20 may diagnose a severity of the vertical streak or predict formation of the vertical streak based on the vertical streak information or the scanning environment information. For example, the server 20 may diagnose the severity of the vertical streak based on a frequency at which a defective level for the vertical streak exceeds a threshold level indicating a level at which adjustment of an intensity level is necessary. For another example, the server 20 may diagnose the severity of the vertical streak by applying the first vertical streak information or the scanning environment information to a trained model for diagnosing the severity of the vertical streak for a scanned image generated by a certain scan job of the image forming device 10. For another example, the server 20 may predict formation of the vertical streak by applying the scanning environment information or the vertical streak candidate information to a trained model for predicting formation of the vertical streak for a certain scanned image to be generated by a certain scan job of the image forming device 10.

In operation 1208, the server 20 may obtain action information for reducing the vertical streak occurrence based on a result of diagnosing the severity of the vertical streak or predicting formation of the vertical streak. The action information may include information of a certain intensity level for adjusting a sensitivity of removing vertical streaks to be occurred by at least one scan job of the image forming device 10, guide information for guiding an operation of the image forming device 10 such that at least one scan job is performed while a certain intensity level is applied, information about diagnosis of a severity of a vertical streak, information about a prediction of formation of a vertical streak, or notification information informing of a visiting service to the image forming device 100. In operation 1209, the server 20 may transmit the action information to the image forming device 10. In operation 1210, the server 20 may transmit the action information to the management device 30.

In operation 1211, the image forming device 10 may perform a certain action according to the action information and may perform a certain scan job.

In operation 1212, the management device 30 may perform monitoring of the image forming device 10, and may prepare a service for the image forming device 10 based on a result of the monitoring and the action determined by the server 20. For example, when the severity of the vertical streak of the image forming device 10 is higher than a reference severity, the management device 30 may prepare a service visit in which a technician inspects or repairs the image forming device 10.

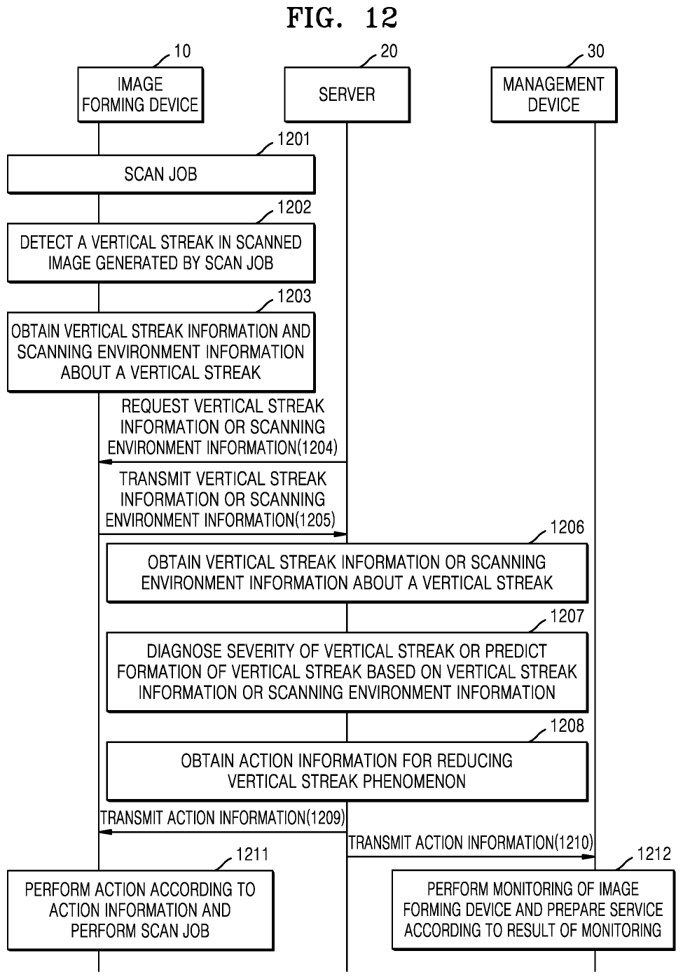

FIG. 13 is a view for describing operations of an image forming device and a server for preventing formation of a vertical streak during a scan job, according to an example.

Referring to FIG. 13, the image forming device 10 may receive a scan job request in operation 1301. In operation 1302, the image forming device 10 may obtain scanning environment information during the scan job. In addition, the image forming device 10 may obtain vertical streak candidate information in a scanned image generated before the scan job.

In operation 1303, the server 20 may request scanning environment information from the image forming device 10. In addition, the server 20 may request the vertical streak candidate information from the image forming device 10. In operation 1304, the image forming device 10 may transmit the scanning environment information and the vertical streak candidate information to the server 20.

In operation 1305, the server 20 may predict formation of a vertical streak due to the scan job based on the scanning environment information and the vertical streak candidate information. For example, the server 20 may predict the formation of a vertical streak due to a certain scan job by applying the scanning environment information and the vertical streak candidate information to a trained model for predicting the formation of a vertical streak for a certain scanned image to be generated by a certain scan job of the image forming device 10.

In operation 1306, when formation of a first vertical streak due to the scan job is predicted from the scanning environment information, the server 20 may obtain first guide information for guiding prevention of formation of the first vertical streak. In operation 1307, the server 20 may transmit the first guide information to the image forming device 10.

In operation 1308, the image forming device 10 may display the first guide information. In the image forming device 10, an action according to the first guide information may be performed. In the image forming device 10, a scanning environment in which a scanned image without a vertical streak occurrence may be generated may be created. In operation 1309, the image forming device 10 may perform a requested scan job.

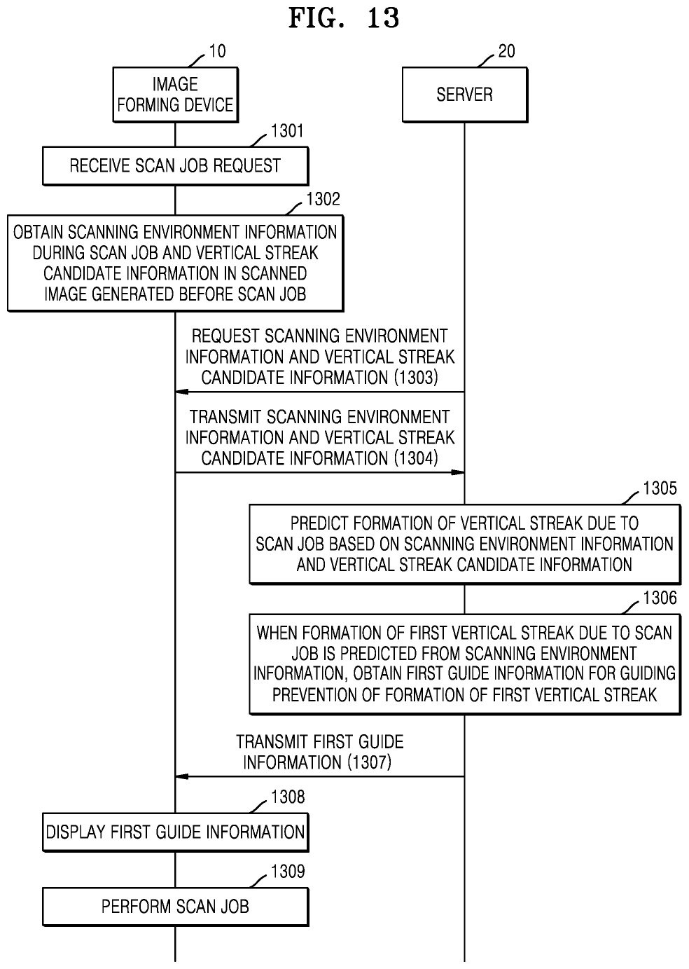

FIG. 14 is a block diagram of a configuration of a server according to an example.

Referring to FIG. 14, the server 20 may include a communication device 1410, a storage 1420, a memory 1430, and a processor 1440. However, the elements shown are not essential elements. The server 20 may include more or fewer elements than the elements shown in FIG. 14. Hereinafter, examples of the elements will be described.

The communication device 1410 may communicate with an external device. As an example, the communication device 1410 may be connected to a network in a wired or wireless manner and may communicate with the external device. Here, the external device may be the image forming device 10, a management device for managing the image forming device 10, an electronic device, or an external server. The communication device 1410 may include a communication module (e.g., a transceiver) that supports one of a variety of wired or wireless communication methods. For example, the communication module may also be a short-range communication module or a wired communication module.

The storage 1420 may store information related to vertical streak information. For example, the storage 1420 may store pieces of vertical streak information and feedback information about the pieces of vertical streak information. The storage 1420 may store information related to a trained model for diagnosing a severity of a vertical streak, the trained model trained based on a correlation between the pieces of vertical streak information and the feedback information about the pieces of vertical streak information, or a correlation between the pieces of vertical streak information and pieces of scanning environment information. In addition, the storage 1420 may store the pieces of vertical streak information and scanning environment information about the pieces of vertical streak information. The storage 1420 may store information related to a trained model for predicting formation of a vertical streak, the trained model trained based on a correlation between the pieces of vertical streak information and the scanning environment information about the pieces of vertical streak information, or a correlation between the pieces of vertical streak information and pieces of vertical streak candidate information corresponding to the pieces of vertical streak information. In addition, the storage 1420 may store various data used in at least one program executed in the server 20.

The memory 1430 may store software or programs. The memory 1430 may store a program used for diagnosing the severity of a vertical streak or predicting formation of a vertical streak.

The processor 1440 may execute a program stored in the memory 1430, read data or a file stored in the memory 1430, or store a new file in the memory 1430. The processor 1440 may execute the instructions stored in the memory 1430.

The processor 1440 may obtain vertical streak information about a vertical streak detected in a scanned image generated by a scan job of the image forming device 10. The vertical streak information may be obtained based on a location, a thickness, a brightness, or a number of vertical streaks detected in each scanned image generated by a scan job. For example, a vertical streak may be detected based on information in which vertical streak candidate information about vertical streak candidate pixels detected in a plurality of scanned images is accumulated. The detected vertical streak information may be obtained as vertical streak sub information, and the vertical streak information may be obtained based on a result of accumulating pieces of vertical streak sub information.

The vertical streak information may include a number, a location, a thickness, or a brightness of vertical streaks included in an accumulated certain scan job load, a number or a location of vertical streaks detected at a certain frequency or more, a presence or absence of fixed vertical streaks, or a defective level of vertical streaks. Also, the defective level of vertical streaks may be determined based on the number, the location, the thickness, or the brightness of vertical streaks, the number or the location of vertical streaks detected at the certain frequency or more, or the presence or absence of fixed vertical streaks.

For example, scanning environment information may be a temperature or a humidity of a location where the image forming device 10 is installed, a scan format of a certain scan job, or a number of scans.

When vertical streak information is obtained in the image forming device 10, the processor 1440 may periodically request the vertical streak information from the image forming device 10 through the communication device 1410. The communication device 1410 may receive vertical streak information from the image forming device 10.

In addition, when the image forming device 10 transmits vertical streak candidate information about vertical streak candidate pixels detected in a plurality of scanned images to the server 20, the processor 1440 may detect a vertical streak based on the vertical streak candidate information, and may obtain vertical streak information about the detected vertical streak.

The processor 1440 may diagnose the severity of a vertical streak or predict formation of a vertical streak based on the vertical streak information or the scanning environment information.

For example, the processor 1440 may diagnose the severity of a vertical streak based on the vertical streak information. In addition, the processor 1440 may diagnose the severity of a vertical streak based on the vertical streak information and the scanning environment information.

For example, the severity of a vertical streak may indicate an extent to which the vertical streak on a scanned image has damaged content of the scanned image or a quality of the scanned image. Here, the severity of the vertical streak may be a reference for determining an intensity level that adjusts the sensitivity of removing the vertical streak to be occurred by at least one scan job of the image forming device 10.

For example, the processor 1440 may diagnose the severity of the vertical streak based on a frequency at which a defective level for a vertical streak exceeds a threshold level. Here, the defective level of a vertical streak may be determined based on a number, a location, a thickness, or a brightness of vertical streaks included in a certain scan job load, a number or a location of vertical streaks detected at a certain frequency or more, or a presence or absence of fixed vertical streaks. The threshold level may indicate a level at which adjustment of an intensity level that adjusts the sensitivity of removing vertical streaks is necessary.

For example, the processor 1440 may diagnose the severity of the first vertical streak by applying first vertical streak information about a first scan job or first scanning environment information at the time of the first scan job to a trained model for diagnosing the severity of a vertical streak for a certain scanned image generated by a certain scan job of the image forming device 10.

In an example, the trained model for diagnosing the severity of a vertical streak may be the trained model for diagnosing the severity of a vertical streak for the certain scanned image, based on a correlation between pieces of vertical streak information and user's feedback information about the pieces of vertical streak information, or a correlation between pieces of vertical streak information and pieces of scanning environment information about the pieces of vertical streak information. For example, the user's feedback information about vertical streaks may include history information with the sensitivity adjusted to remove vertical streaks in the image forming device 10 or history information for applying for a diagnosis or repair service due to a vertical streak occurrence. That is, the processor 1440 may diagnose the severity of the vertical streak by reflecting a correlation between the vertical streak information and the user's feedback information or a correlation between characteristics of the vertical streak and characteristics of a scanning environment in which the vertical streak is detected, thereby accurately diagnosing the severity according to the state of the vertical streak included in a scanned image.

For example, the processor 1440 may predict formation of a vertical streak based on the vertical streak information and the scanning environment information. The vertical streak information may include vertical streak candidate information. The vertical streak candidate information may be obtained based on a location, a brightness, or a number of vertical streak candidate pixels detected in a scanned image.

For example, the processor 1440 may obtain scanning environment information during a first scan job of the image forming device 10 and vertical streak candidate information in a scanned image generated before the first scan job. The processor 1440 may receive the scanning environment information and the vertical streak candidate information from the image forming device 10 through the communication device 1410.

For example, the scanning environment information may include a temperature or a humidity of a location where the image forming device 10 is installed, a scan format, or a number of scans. The vertical streak candidate information may be obtained based on a location, a brightness, or a number of vertical streak candidate pixels detected in a scanned image. The processor 1440 may predict formation of a vertical streak due to a certain scan job by applying the scanning environment information and the vertical streak candidate information to a trained model for predicting the formation of vertical streaks for a certain scanned image to be generated by a certain scan job of the image forming device 10.

In an example, the trained model for predicting formation of a vertical streak may be a trained model that predicts formation of a vertical streak for a certain scanned image, based on a correlation between pieces of vertical streak information and pieces of scanning environment information about the pieces of vertical streak information, or a correlation between the pieces of vertical streak information and pieces of vertical streak candidate information corresponding to the pieces of vertical streak information.

In an example, the trained model for predicting formation of a vertical streak may generate a trained model that predicts in which scanning environment a vertical streak may form during scanning and in which vertical streak candidate a vertical streak may form during scanning, by learning a correlation between a scanning environment of the image forming device 10 and whether vertical streaks form in the scanning environment or a correlation between vertical streak information and vertical streak candidate information corresponding to the vertical streak information.

The processor 1440 may obtain action information for reducing a vertical streak occurrence based on a result of diagnosing the severity of vertical streaks or predicting the formation of vertical streaks. The communication device 1410 may transmit the action information to the image forming device 10 or the management device 30 managing the image forming device 10.

For example, the action information for reducing the vertical streak occurrence may include information of a certain intensity level for adjusting the sensitivity of removing vertical streaks to be occurred by at least one scan job of the image forming device 10, guide information for guiding the operation of the image forming device 10 such that at least one scan job is performed while a certain intensity level is applied, information about diagnosis of the severity of a vertical streak, information about prediction of formation of a vertical streak, or notification information informing of a service visit to the image forming apparatus 10.

For example, the processor 1440 may determine a first intensity level based on a result of diagnosing the severity of a vertical streak or predicting formation of a vertical streak.

For example, if the severity of a vertical streak is determined to be higher than a preset reference severity or if a certain vertical streak is expected to occur, the processor 1440 may determine the intensity level as a first intensity level adjusted upward from a reference intensity level.

For example, if the severity of a vertical streak is determined to be lower than the preset reference severity, the processor 1440 may maintain the intensity level at the reference intensity level. Here, if there is a history in which the intensity level is adjusted upward from the reference intensity level, the processor 1440 may determine the first intensity level by adjusting the intensity level downward.

The processor 1440 may transmit diagnosis result information including information of the first intensity level to the image forming device 10 or a management device managing the image forming device 10 through the communication device 1410.

For example, the communication device 1410 may transmit guide information for guiding an operation of the image forming device 10 to perform at least one scan job in a state where the first intensity level is applied to the intensity level.

For example, the communication device 1410 may transmit information about diagnosis of the severity of vertical streaks, information about prediction of the formation of vertical streaks, or notification information informing a visiting service to the image forming device 10.

When formation of a first vertical streak due to a certain scan job is predicted from the scanning environment information, the processor 1440 may obtain first guide information for guiding prevention of the formation of the first vertical streak. The communication device 1410 may transmit the first guide information to the image forming device 10.

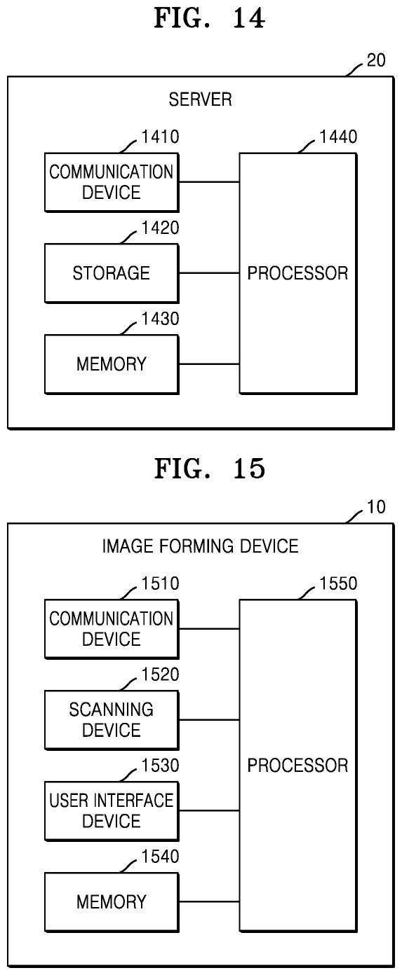

FIG. 15 is a block diagram of a configuration of an image forming device according to an example.

Referring to FIG. 15, the image forming device 10 may include a communication device 1510, a scanning device 1520, a user interface device 1530, a memory 1540, and a processor 1550. However, the elements shown are not essential elements. The image forming device 10 may include more or fewer elements than the elements shown in the drawings. Hereinafter, the elements will be described.

The communication device 1510 may communicate with an external device. As an example, the communication device 1510 may be connected to a network in a wired or wireless manner and may communicate with the external device. The external device may be an external server that manages the image forming device 10, the management device 30 that manages the image forming device 10, or an electronic device. The communication device 1510 may include a communication module (e.g., a transceiver) that supports one of a variety of wired or wireless communication methods. For example, the communication module may also be a short-range communication module or a wired communication module.

The scanning device 1520 may generate a scanned image by performing a certain scan job in response to a request of the certain scan job in the image forming device 10. For example, the scanning device 1520 may include an automatic document feeder (ADF) for automatic feeding of documents.

The user interface device 1220 may include an input unit for receiving, from a user, an input for controlling the operation of the image forming device 10, and an output unit for displaying information, such as a result of the operation of the image forming device 10 or a state of the image forming device 10. For example, the user interface device 1530 may include an operation panel for receiving a user input, a display panel for displaying a screen, or the like.

As an example, the input unit may include a device for receiving various types of user inputs, such as a keyboard, a physical button, a touch screen, a camera, or a microphone. Also, the output unit may include, for example, a display panel or a speaker. However, an example is not limited thereto, and the user interface device 1530 may include a device supporting various inputs and outputs.

The memory 1540 may store software or programs. The memory 1540 may store at least one program used to detect vertical streaks on the scanned image and to remove vertical streaks. The memory 1540 may also store at least one program used for diagnosing a severity of a vertical streak or predicting formation of a vertical streak.

The processor 1550 may execute a program stored in the memory 1540, read data or a file stored in the memory 1540, or store a new file in the memory 1540. The processor 1550 may execute the instructions stored in the memory 1540.

The processor 1550 may control a scan job to be performed in the scanning device 1520 according to a scan job request. The processor 1550 may detect a vertical streak in a scanned image generated from the scan job.

For example, the processor 1550 may determine a vertical streak candidate pixel based on characteristics of a depth, a thickness, or a color for each pole detected on the scanned image. For example, the processor 1550 may determine a pixel of a certain pole as the vertical streak candidate pixel based on whether the certain pole is the maximum or minimum point, whether the difference in brightness between pixels of a certain pole and surrounding pixels is within a preset range, or based on a color presence or a color ratio between the pixels of the certain pole and the surrounding pixels.

The processor 1550 may obtain vertical streak candidate information about each scan page and store the vertical streak candidate information during a scan job. The vertical streak candidate information may include location information of the vertical streak candidate pixel. The processor 1550 may detect a vertical streak based on a result of accumulating pieces of vertical streak candidate information. The image forming device 10 may obtain vertical streak information about a vertical streak.

The processor 1550, based on a result of accumulating pieces of vertical streak candidate information, may detect a pixel in which the vertical streak candidate pixels consecutively accumulated at a certain location are greater than or equal to a certain size, or a pixel in which the frequency of formation of the vertical streak candidate pixels consecutively accumulated at a certain location is greater than or equal to a certain number. The processor 1550 may obtain vertical streak information including a number, a location, a thickness, or a brightness of vertical streaks included in an accumulated scan job load, a number or a location of vertical streaks detected at a certain frequency or more, a presence or absence of fixed vertical streaks, or a defective level of vertical streaks.

The processor 1550 may obtain action information for reducing a vertical streak occurrence based on the vertical streak information or the scanning environment information. For example, the processor 1550 may transmit the vertical streak information or the scanning environment information to the server 20 for monitoring a result of a scan job of the image forming device 10 through the communication device 1510. The communication device 1510 may receive the action information, from the server 20, determined based on a result of diagnosing the severity of a vertical streak or predicting formation of a vertical streak.

For example, the action information may include information of a certain intensity level for adjusting the sensitivity for removing vertical streaks to be occurred by at least one scan job of the image forming device 10, guide information for guiding the operation of the image forming device 10 such that at least one scan job is performed while a certain intensity level is applied, information about diagnosis of the severity of vertical streaks, information about prediction of the formation of vertical streaks, or notification information informing of a visiting service to the image forming device 100.

For another example, the processor 1550 may diagnose the severity of a vertical streak or predict formation of a vertical streak based on one or more of the vertical streak information and the scanning environment information.

The processor 1550 may diagnose the severity of a vertical streak based on a frequency at which a defective level for a vertical streak exceeds a threshold level. In addition, the processor 1550 may learn a trained model for diagnosing the severity of a vertical streak for a certain scanned image, based on a correlation between pieces of vertical streak information and user's feedback information about the pieces of vertical streak information, or a correlation between pieces of vertical streak information and pieces of scanning environment information about the pieces of vertical streak information. The processor 1550 may diagnose the severity of the first vertical streak by applying first vertical streak information or first scanning environment information to a trained model for diagnosing the severity of a vertical streak for a certain scanned image generated by a certain scan job of the image forming device 10.

In addition, the processor 1550 may learn a trained model for predicting the formation of a vertical streak for a certain scanned image, based on a correlation between pieces of vertical streak information and pieces of scanning environment information about the pieces of vertical streak information, or a correlation between the pieces of vertical streak information and pieces of vertical streak candidate information corresponding to the pieces of vertical streak information. For example, the scanning environment information may include a temperature or a humidity of a location where the image forming device 10 is installed, a scan format, or a number of scans. The vertical streak candidate information may be obtained based on a location, a brightness, or a number of vertical streak candidate pixels detected in a scanned image.

The processor 1550 may obtain scanning environment information during a first scan job of the image forming device 10 and vertical streak candidate information in a scanned image generated before the first scan job. The processor 1550 may predict formation of a vertical streak due to a certain scan job by applying the scanning environment information and the vertical streak candidate information to a trained model for predicting the formation of vertical streaks for a certain scanned image to be generated by a certain scan job of the image forming device 10.

The processor 1550 may obtain information about diagnosis of a severity of a vertical streak and action information for reducing a vertical streak occurrence.

For example, if the severity of a vertical streak is determined to be higher than a preset reference severity or if a certain vertical streak is expected to occur, the processor 1550 may determine the intensity level as a first intensity level adjusted upward from a reference intensity level. Also, if the severity of a vertical streak is determined to be lower than the preset reference severity, the processor 1550 may maintain the intensity level at the reference intensity level. Here, if there is a history in which the intensity level is adjusted upward from the reference intensity level, the processor 1550 may determine the first intensity level by adjusting the intensity level downward.

The user interface device 1530 may display action information. For example, the user interface device 1530 may display information of the first intensity level for adjusting the sensitivity of removing vertical streaks. In addition, the user interface device 1530 may display guide information for guiding an operation of the image forming device 10 to perform at least one scan job in a state where the first intensity level is applied. In addition, the user interface device 1530 may display information about diagnosis of the severity of a vertical streak, information about prediction of formation of a vertical streak, or notification information informing of a visiting service to the image forming device 10.

Also, when the formation of a first vertical streak due to a certain scan job is predicted from the scanning environment information, the user interface device 1530 may display first guide information for guiding prevention of the formation of the first vertical streak.

The example operating methods of the image forming device 10, the server 20, and the management device 30 described above may be implemented in the form of a non-transitory computer-readable recording medium storing instructions or data executable by a computer or a processor. The examples may be written as computer programs and may be implemented in general-use digital computers that execute programs using the computer-readable recording medium. The computer-readable recording medium may include read only memory (ROM), random access memory (RAM), flash memory, CD-ROMs, CD-Rs, CD+Rs, CD-DVD-Rs, DVD-Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device capable of storing instructions or software, associated data, data files, and data structures, and providing the instructions or software, associated data, data files, and data structures to a processor or a computer such that the processor or computer may execute the instructions.

Although examples have been described with reference to the accompanying drawings, those of ordinary skill in the art will understand that various changes and modifications may be made therein. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. An operating method of a server, the method comprising:
obtaining vertical streak information or scanning environment information about a vertical streak detected in a scanned image;
diagnosing a severity of the vertical streak or predicting formation of the vertical streak, based on the vertical streak information or the scanning environment information; and
based on a result of diagnosing the severity of the vertical streak or predicting formation of the vertical streak, transmitting, to an image forming device or a management device managing the image forming device, action information for reducing a vertical streak occurrence.

2. The method of claim 1, wherein the diagnosing of the severity of the vertical streak based on the vertical streak information or the scanning environment information comprises:
diagnosing the severity of the vertical streak based on a frequency at which a severity level of the vertical streak exceeds a threshold level indicating a level at which adjustment of a level of intensity for removal of a certain vertical streak is necessary.

3. The method of claim 1, wherein the diagnosing of the severity of the vertical streak based on the vertical streak information or the scanning environment information comprises:
diagnosing the severity of the vertical streak by applying the vertical streak information or the scanning environment information to a trained model for diagnosing the severity of the vertical streak for a certain scanned image.

4. The method of claim 3, further comprising:
learning the trained model for diagnosing the severity of the vertical streak for the certain scanned image, based on a correlation between pieces of the vertical streak information and user feedback information about the pieces of the vertical streak information, or a correlation between the pieces of the vertical streak information and pieces of scanning environment information about the pieces of vertical streak information.

5. The method of claim 1,
wherein the action information for reducing the vertical streak occurrence comprises information of an intensity level for adjusting a sensitivity for removing vertical streaks to be formed by at least one scan job of the image forming device, and
wherein the method further comprises determining a first intensity level based on a result of diagnosing the severity of the vertical streak or predicting formation of the vertical streak.

6. The method of claim 5, wherein the determining of the first intensity level comprises:
determining the intensity level as the first intensity level adjusted upward from a reference intensity level, when the severity of the vertical streak is determined to be higher than a preset reference severity or when a certain vertical streak is expected to be formed; and
maintaining the intensity level at the reference intensity level when the severity of the vertical streak is determined to be lower than the preset reference severity.

7. The method of claim 1, wherein the obtaining of the vertical streak information about the vertical streak comprises
obtaining the vertical streak information based on a number, a location, a thickness, or a brightness of a plurality of vertical streaks detected in a plurality of scanned images.

8. The method of claim 1, wherein the transmitting of the action information for reducing the vertical streak occurrence comprises:
transmitting information of a first intensity level for adjusting a sensitivity for removing the vertical streak to be formed by at least one scan job of the image forming device;
transmitting guide information for guiding an operation of the image forming device to perform the at least one scan job in a state where the first intensity level is applied; or
transmitting information about the diagnosis of the severity of the vertical streak, information about the prediction of formation of the vertical streak, or notification information providing information about a visiting service for the image forming device.

9. The method of claim 1, wherein the predicting of formation of the vertical streak based on the vertical streak information or the scanning environment information further comprises:
obtaining scanning environment information during a first scan job of the image forming device and vertical streak candidate information in a scanned image generated before the first scan job; and
predicting formation of the vertical streak due to the first scan job by applying the scanning environment information and the vertical streak candidate information to a trained model for predicting formation of the vertical streak for a certain scanned image.

10. The method of claim 9, further comprising learning a trained model for predicting formation of the vertical streak for the certain scanned image, based on a correlation between pieces of vertical streak information and pieces of scanning environment information about the pieces of vertical streak information, or a correlation between the pieces of vertical streak information and pieces of vertical streak candidate information corresponding to the pieces of vertical streak information.

11. The method of claim 9, wherein the transmitting of the action information for reducing the vertical streak occurrence to the image forming device further comprises:
when formation of a first vertical streak is predicted from the scanning environment information, obtaining first guide information for guiding prevention of formation of the first vertical streak; and
transmitting the first guide information to the image forming device.

12. A server comprising:
a communication device to communicate with an image forming device;
a storage;
a processor; and
a memory to store instructions executable by the processor,
wherein the processor executes the instructions to:
obtain vertical streak information or scanning environment information about a vertical streak detected in a scanned image;
diagnose a severity of the vertical streak or predict formation of the vertical streak based on the vertical streak information or the scanning environment information; and
based on a result of diagnosing the severity of the vertical streak or predicting formation of the vertical streak, transmit, to the image forming device or a management device managing the image forming device, action information for reducing a vertical streak occurrence.

13. An image forming device comprising:
a communication device to communicate with an external device;
a scanning device;
a user interface device;
a processor; and
a memory to store instructions executable by the processor,
wherein the processor is to execute the instructions to:
detect a vertical streak in a scanned image;
obtain vertical streak information or scanning environment information about the vertical streak;
obtain action information for reducing a vertical streak occurrence based on the vertical streak information or the scanning environment information;
perform a certain action according to the action information; and
perform at least one scan job.

14. The image forming device of claim 13, wherein the processor is to further execute the instructions to:
transmit the vertical streak information or the scanning environment information to a server for monitoring a result of a scan job of the image forming device; and
receive, from the server, the action information determined based on a result of diagnosing a severity of the vertical streak or predicting formation of the vertical streak.

15. An image forming device comprising:
a communication device to communicate with an external device;
a scanning device;
a user interface device;
a processor; and
a memory to store instructions executable by the processor,
wherein the processor executes the instructions to:
detect a vertical streak in a scanned image;
obtain vertical streak information or scanning environment information about the vertical streak;
diagnose a severity of the vertical streak or predict formation of the vertical streak based on the vertical streak information or the scanning environment information;
obtain action information for reducing a vertical streak occurrence based on a result of diagnosing the severity of the vertical streak or predicting formation of the vertical streak; and
perform a certain action according to the action information and perform a scan job.
